(19) United States
(12) Patent Application Publication
(10) Pub. No.: US 2026/0197225 A1
(43) Pub. Date: Jul. 9, 2026

(54) WIRELESS ACCESS POINT MONITORING AND RESET CONTROL

(71) Applicant: Charter Communications Operating, LLC, St. Louis, MO (US)

(72) Inventor: Shlomo Ovadia, Denver, CO (US)

(21) Appl. No.: 19/015,271

(22) Filed: Jan. 9, 2025

(51) Int. Cl. H04L 41/0654; H04W 24/08; H04W 76/20

(52) U.S. Cl. CPC H04L 41/0654; H04W 24/08; H04W 76/20

(57) ABSTRACT

At a first instant of time, a communication management system transmits test communications from a cloud-connected wireless router to test an ability of the wireless router to communicate with at least one remote destination. The communication management system then monitors for receipt of each reply communications at the wireless router in response to transmitting each of the test communications. Based on the monitoring, the communication management system determines if and when to reboot the cloud-connected wireless router, and provides information such as the reboot type and history to a cloud-based diagnostic system.

### BACKGROUND

Conventional wireless technology has been used for many years to connect wireless devices such as phones, laptops, etc., to a landline network and other wireless networks. Today, such wireless networks support many different types of connection services and uses cases such as voice communications, cellular communications, high-speed data services, Wi-Fi™ connectivity, and so on.

Cable network service providers typically have many field-deployed wireless access points, serving residential subscribers and small-medium size businesses. A wireless access point may be connected and powered by so-called power over ethernet. There are various use cases in which a respective Wi-Fi™ router requires remote rebooting such as loss of connectivity. In addition to the loss of network connectivity, there are other conditions, which may require the Wi-Fi™ router to be rebooted such as high RAM memory usage (>80%-90%) during the day, which leads to poor Wi-Fi™ performance, or memory leaks, which are mainly due to firmware issues.

A so-called memory leak may occur when a process requests or allocates memory and then forgets to free (de-allocate) the memory when it is finished with that task. As a result, the memory block is reserved until the router is reloaded. Over time, more and more memory blocks are allocated by that process until there is no free memory available. The rate at which free memory available for use reduces overtime depends on how often the event occurs that leads to the leak. A memory leak is a complex condition sometimes requiring an OS (Operating System) upgrade to correct.

### BRIEF DESCRIPTION OF EXAMPLES

This disclosure includes the observation that it desirable in certain instances to perform a respective reboot of a wireless router via communications over a network to which the wireless router is attached. Accordingly, to provide better use of wireless resources in a network environment, techniques as discussed herein provide novel techniques of controlling reset (such as reboot and other reset or control functions as discussed herein) operation of one or more wireless routers to provide improved wireless access to respective mobile communication devices.

More specifically, as discussed herein, a communication system includes a management resource. The management resource performs any of the operations as discussed herein. At a first instant of time, the management resource (a.k.a., performance monitor or other suitable entity including one or more of management hardware, management software, performance monitor hardware, performance monitor software, communication management resource, communication management hardware, communication management software, etc., controlling operation of the wireless router) transmits first test communications from the wireless router (such as a wireless access point, wireless station, etc.) to test an ability of the wireless router to communicate with at least one remote destination. The management resource monitors for receipt of first reply communications at the wireless router in response to transmitting the first test communications. Based on the monitoring, the management resource controls resetting (such as rebooting, depowering/powering, power cycling, etc.) of the wireless router based on the monitoring.

In one example, control of resetting the wireless router based on monitoring may include the management resource initiating the reset of the wireless router in response to detected failure of the wireless router or other suitable entity receiving a reply message from any of the at least one remote destination within a threshold amount of time with respect to the first instant of time.

In further examples, control of resetting the wireless router based on monitoring may include the management resource preventing the reset of the wireless router in response to the wireless router receiving at least one reply message from any of the remote destinations within a threshold amount of time with respect to the first instant of time.

Still further, examples herein include the management resource: transmitting a first test message from the wireless router over a backhaul communication link to a first remote destination around the first instant of time; and transmitting a second test message from the wireless router over the backhaul communication link to a second remote destination around a second instant of time. In such an instance, monitoring for receipt of reply communications at the wireless router or other suitable entity may include the management resource or other suitable entity: i) monitoring for receipt of a first reply communication from the first remote destination in response to transmitting the first test message; and ii) monitoring for receipt of a second reply communication from the second remote destination in response to transmitting the second test message.

In accordance with still further examples as discussed herein, the management resource or other suitable entity can be configured to transmit multiple test communications from the wireless router. For example, at a second instant of time subsequent to the first instant of time, the management resource can be configured to transmit second test communications from the wireless router to test the ability of the wireless router to communicate with the at least one remote destination. The management resource monitors for receipt of second reply communications at the wireless router in response to transmitting the second test communications. The management resource then controls the reboot of the wireless router based on the monitoring for receipt of the first reply communications and the second reply communications.

Yet further examples as discussed herein include the management resource generating log information indicating a communication failure associated with the wireless router based at least in part on the wireless router failing to receive the first reply communications. The management resource can be configured to communicate the log information from the wireless router to a remotely located management resource.

In yet another example, the wireless router is configured to provide multiple communication devices access to a remote network via wireless connectivity between the wireless router and the multiple communication devices.

As previously discussed, controlled reset of the wireless router (a.k.a., wireless access point, wireless station, etc.) may include any suitable operations. In one example, control of the reset includes the management resource or other suitable entity rebooting a communication management function in the wireless router in response to a detected operational error (such as fault) condition associated with the wireless router. The operational error condition (such as the wireless router operating below a performance threshold level) may be determined based at least in part on failure to receive the first reply communications at the wireless router in response to transmitting the first test communications. The management function is operative to support wireless connectivity between multiple mobile communication devices and a remote network during non-failure of the wireless router. In one example, rebooting the communication management function as previously discussed includes a condition in which the wireless router will be rebooted. In another example, the rebooting is essentially a soft reboot of the part of software stack of the router.

In accordance with further examples, the system as discussed herein includes a communication management resource. The communication management resource receives a first time value associated with transmission of a first test communication over a network and through a gateway to a wireless router, the gateway operative to provide a wireless router connectivity to a remote network. The communication management resource further receives a second time value associated with transmission of a second test communication over the network to the gateway. Based upon the first time value and the second time value, the communication management resource determines an operational state of the wireless router

In one example, the communication management resource calculates a difference value based on a difference between the first time value and the second time value. The communication management resource determines that a magnitude of the first time value is greater than a magnitude of the second time value. Still further, the communication management resource can be configured to: compare a magnitude of the difference value to a threshold level; and produce a notification indicating the operational state of the wireless router as being a failure state in response to detecting that the magnitude of the difference value is greater than the threshold level.

In a further example as discussed herein, the first time value is based on a first time duration associated with conveying the first test communication over the network through the gateway to the wireless router. The second time value is based on a second time duration associated with conveying the second test communication over the network to the gateway.

In still further examples, the communication management resource can be configured to, in response to detecting that the operational state of the wireless router is a failure state, transmit a command to reset the wireless router, which includes resetting or rebooting any of one or more instances of circuitry in the wireless router. The communication management resource can be configured to determine that the operational state of the wireless router is in the failure state (such as performance below a threshold level) based on a difference between the first time value and the second time value.

Yet further, the communication management resource or other suitable entity can be configured to generate log information indicating the failure or non-failure state; the communication management resource or other suitable entity then communicates the log information to a remote management resource tracking operation of the wireless router.

In further examples, the wireless router or other suitable entity is configured to provide multiple communication devices access to a remote network via wireless connectivity between the wireless router and the multiple communication devices.

Still further, the communication management resource or other suitable entity can be configured to: i) produce the first time value via transmitting the first test communication over the network and through the gateway to the wireless router at a first instant of time, where the first time value is a first measured difference in time between the first instant of time and a time of the communication management resource receiving a response communication from the wireless router; and ii) produce the second time value transmitting the second test communication over the network to the gateway at a second instant of time, where the second time value is a second measured difference in time between the second instant of time and a time of the communication management resource receiving a response communication from the gateway resource.

Note further that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable hardware storage on which software instructions are encoded for subsequent execution. The computer-readable storage hardware for storing instructions may be configured as a non-transitory computer-readable storage medium. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on computer-readable storage hardware such as a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example herein includes computer-readable storage hardware and/or system having instructions stored thereon. The instructions, when executed by the computer processor hardware, cause the computer processor hardware (such as one or more co-located or disparately processor devices or hardware) to: at a first instant of time, transmit first test communications from the wireless router to test an ability of the wireless router to communicate with at least one remote destination; monitor for receipt of first reply communications at the wireless router in response to transmitting the first test communications; and control a reset of the wireless router based on the monitoring.

Another example herein includes computer-readable storage hardware and/or system having instructions stored thereon. The instructions, when executed by the computer processor hardware, cause the computer processor hardware (such as one or more co-located or disparately processor devices or hardware) to: produce a first time value associated with transmission of a first test communication over a network and through a gateway to a wireless router, the gateway operative to provide a wireless router connectivity to a remote network; produce a second time value associated with transmission of a second test communication over the network to the gateway; and determine an operational state of the wireless router based upon the first time value and the second time value.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity via controlled resetting of respective wireless routers and corresponding circuitry therein. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment including one or more wireless routers implementing a first wireless router reset control method as discussed herein.

FIG. 2 is an example diagram illustrating transmission of one or more test communications to at least one remote network nodes in a network environment to test a performance of a respective wireless router as discussed herein.

FIG. 3 is an example diagram illustrating a corresponding moving window of time with respect to times of transmitting messages from and receiving messages at a wireless router to determine performance of the wireless router as discussed herein.

FIG. 4 is an example diagram illustrating a corresponding moving window of time with respect to times of transmitting messages from and receiving messages at a wireless router to determine performance of the wireless router as discussed herein.

FIG. 5 is an example diagram illustrating a network environment and corresponding communication management resource implementing a first test ping associated with a wireless router reset control method as discussed herein.

FIG. 6 is an example diagram illustrating a network environment and corresponding communication management resource implementing a second test ping associated with a second wireless router reset control method as discussed herein.

FIG. 7 is an example diagram illustrating a method of determining whether to issue a reset of a respective wireless router based multiple test ping tests as discussed herein.

FIG. 8 is an example diagram illustrating a dashboard indicating a respective health of a wireless router as discussed herein.

FIG. 9 is an example diagram illustrating parameters associated with creating a table of information indicating occurrence of different types of wireless router failures/resets as discussed herein.

FIG. 10 is an example diagram illustrating a log of wireless router failures as discussed herein.

FIG. 11 is an example diagram illustrating example computer hardware and software (such as executable instructions) operable to execute operations as discussed herein.

FIG. 12 is an example diagram illustrating a first wireless router reset control method as discussed herein.

FIG. 13 is an example diagram illustrating a second wireless router reset control method as discussed herein.

The foregoing and other objects, features, and advantages of the invention (as described in the following examples) will be apparent from the following more particular description of preferred implementations herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

### First Wireless Router Control System (Auto-Reboot Control Method 1)

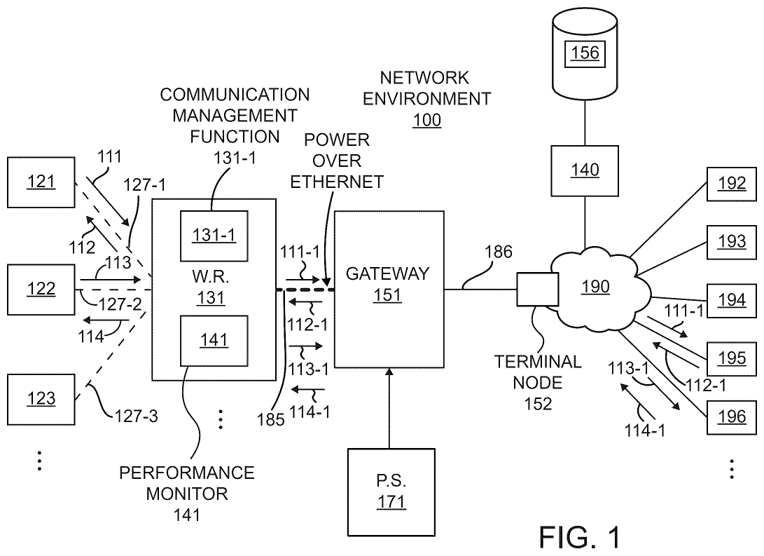

FIGS. 1-4 and corresponding description below describe implementation of a first reboot system configured to reboot (reset) one or more wireless routers and corresponding circuitry or software therein in a network environment based on communication path test results.

In different examples, the system as described herein may include:
Use of a wireless router such as a Wi-Fi™ 6E router to send real-time requests concurrently every time period such as 5 seconds or other suitable amount to one or more well-known websites (see below). Requests may be based on Internet Message Control Protocol (ICMP). In general, ICMP is a network layer error-reporting protocol that's used to communicate data transmission problems.
implementation of a time window such as 30-second timeout window or other suitable value to determine fault conditions
invocation of a 30 second timeout may be a condition such as when all the ICMP responses failed
   Alternatively, if there is one successful ICMP response, then there is no failed timeout window. The communication system continues to send ICMP requests every 5 seconds for the next 30 second window, and so on. In such an instance, the communication system can be configured to:
Initiate a retry attempt for a second 30 second windows after the first 30-second window timeout failed in order to mitigate false positive events
Initiate from the OpenSync Cloud an auto-reboot for the Wi-Fi™ router (see further details below). In a further example (with reference to FIGS. 1-5 as previously discussed and as will be further discussed in more detail below), during conditions when there is no failure, the wireless router 131 (and any functions therein) may be in communication with a so-called OpenSync cloud function disposed in the network environment 100. If the wireless router 131 as discussed herein loses connectivity with the OpenSync cloud (management resource), the router's performance monitoring software (such as performance monitor 141 or other suitable entity) be configured reboot the wireless router 131. This is the backup option.

More specifically, in accordance with the backup option, the OpenSync™ cloud may be a cloud-agnostic open-source software that includes one or more managers running as separate processes and performing their specific set of tasks. In one example, the CM is part of the OpenSync layer integrated in the wireless router's software stack. A Connectivity manager (a.k.a., CM) such as a software component in the wireless router 131 located elsewhere may be one of the OpenSync managers that is responsible for monitoring and maintaining connectivity to the OpenSync cloud. The connectivity manager may be part of the performance monitor 141 as discussed herein. Specifically, it can be configured to monitor the Open v Switch database (OVSDB) configuration and actively stores it in persistent storage.

In a further example, when the router's performance monitoring software such as performance monitor 141 or other suitable entity associated with the wireless router 131 determines that the wireless router 131 needs to be rebooted (based on one, two, or any number of failed time windows 310 as further discussed herein), the performance monitor 141 can be configured to check that the wireless router 131 is connected to the OpenSync cloud controller via the CM. When the CM of the wireless router 131 determines that the IP connectivity to the OpenSync cloud controller is lost, the CM can be configured to trigger the wireless router or any corresponding functions therein to the rebooted (or reset) either immediately or after some delay amount of time based on the router settings.

Open v switch (a.k.a., OVS) is an open-source implementation of distributed virtual multi-layer switch.

Thus, in another example, reset of the wireless router 131 by the performance monitor 141 or other suitable at the occurs only after there is a second failed 30 second window, then auto-reboot is initiated from the Open-Sync cloud. However, as discussed herein, the execution of a reset of the wireless router 131 may occur in response to detecting any number of failed windows of testing as previously discussed or as further discussed herein.
Re-start ICMP the test process (request and response messages) after the Wi-Fi 6E router completed its auto-reboot
Limit the number of auto-reboot trials for a specific Wi-Fi 6E router issue (such as 5), excluding Mains power failure and firmware upgrade
Other common websites for transmitting test communications can be added to the list of well-known website list such as:
webpage #1 such as www.site1.com such as Google.com
webpage #2 such as www.site2.com such as Microsoft.com
webpage #3 such as www.site3.com such as 8.8.8.8

Reset criteria:
Reboot the wireless router when there are two consecutive timeout windows with failed ICMP responses to one or all of the listed websites.
Exclude any Mains power failure events
Exclude any modem or Wi-Fi router firmware upgrade events

OpenSync Cloud monitoring and Diagnostics:
Set-up a monitoring server with a dashboard to monitor the received wireless router pings.
Establish baseline history:
wireless router periodically sends (i.e., such as every 3-12 hours) successful ICMP requests/responses to establish baseline history
If there are any ICMP response failures after the second window timeout, enable the wireless router to stream the failed test results to the OpenSync Cloud
Exclude any Mains power failure events
Exclude any modem or wireless router firmware update
Collect these ICMP response failures as part of the Wi-Fi 6E router performance metrics (KPI)
Perform real-time diagnostics using AI/ML algorithms to identify and troubleshoot any specific Wi-Fi 6E router/modem in a specific geo area.

Now, with reference to the drawings, FIG. 1 is an example diagram illustrating a wireless network environment and wireless access reset control as discussed herein.

As shown in FIG. 1, the network environment 100 includes wireless router 131 such as a Wi-Fi™ router or other suitable entity, power source 171, gateway 151, network 190, and communication management system 140.

Note that the network environment 100 can be configured to include any number of wireless access points.

Additionally, note that the resources shown in FIG. 1 can be implemented in any suitable manner. In one example, the wireless router 131 can be configured as wireless router/router hardware, executed wireless router software, or a combination of wireless router/router hardware and executed wireless router software; the communication management function 131-1 can be implemented as communication management hardware, communication management software, or a combination of communication management hardware and executed communication management software; performance monitor 141 (a.k.a., communication management resource, management resource, wireless router controller, etc.) can be implemented as performance monitor hardware, performance monitor software, or a combination of performance monitor hardware and executed performance monitor software; gateway 151 (such as a gateway resource; note that the gateway resource may be a Gateway Device such as cable modem with Voice functionality/ports) can be implemented as gateway hardware, gateway software, or a combination of hardware and gateway software; communication management system 140 can be implemented as communication management hardware, communication management software, or a combination of communication management hardware and communication management software; and someone.

Further in this example, the wireless router 131 provides multiple communication devices (such as one or more of laptops, desktop tablets, mobile phones, mobile devices, mobile communication devices, handheld devices, user equipment, etc.) access to a remote network 190 (such as service provider network or any other network) and corresponding resources such as server resource 195, server resource 196, server resource 197, etc.

For example, via the wireless communication link 127-1 and implementation of the communication management function 131-1, the mobile communication device 121 transmits corresponding wireless communications 111 to the wireless router 131. The wireless communications 111 received from the mobile communication device 121 may include a request from a respective server resource 195 for retrieval of content such as webpage information. The router/wireless router 131 forwards the request communications 111 received over the wireless communication link 127-1 as communications 111-1 transmitted through the communication link 185, gateway resource 151, communication link 186, and the network 190 to the target server resource such as server resource 195.

In response to receiving the request for content as indicated by the request communications 111-1, the server resource 195 transmits the response communications 112-1 (such as requested content such as webpage information as indicated by the request communications) over the network 190 through the gateway 151 to the wireless router 131. The wireless router 131 further transmits the response communications 112-1 as communications 112 over the wireless communication link 127-1 to the mobile communication device 121. Accordingly, the mobile communication device 121 can be configured to request webpage information via the wireless communications 111 (as further discussed below, the communications 111 include requests resulting in corresponding responses to each of the communication devices) and received corresponding requested webpage information from the server resource 195 via the communications 112.

In a similar manner, each of the communication devices (such as mobile communication devices, user equipment, stationary communication devices, etc.) is able to communicate over a respective wireless communication link to the wireless router to retrieve requested content.

More specifically, via the wireless communication link 127-2, the communication device 122 transmits corresponding wireless communications 113 to the wireless router 131. The communications 113 received from the communication device 121 may include a request from a respective server resource 196 for retrieval of content. The wireless router 131 forwards the request communications 113 received over the wireless communication link 127-2 as communications 113-1 through a combination of the communication link 185, the gateway resource 151, communication link 186, termination node 152, and the network 190 to the target server resource such as server resource 196.

In response to receiving the request for content as indicated by the request communications 113-1, the server resource 196 transmits the response communications 114-1 (such as requested content such as webpage information as indicated by the request communications) over the network 190 through the gateway resource 151 to the wireless router 131. The wireless router 131 further transmits the response communications 114-1 as communications 114 over the wireless communication link 127-2 to the communication device 122.

Accordingly, the mobile communication device 122 can be configured to request webpage information via the wireless communications 113 and receive corresponding requested webpage information from the server resource 195 via the communications 114.

In a similar manner, each of the communication devices in wireless communication with the wireless router 131 is able to retrieve content from one or more server resources associated with the network 190.

Note that the wireless router 131 and corresponding communication devices 121, 122, 123, etc., may reside in a respective subscriber domain such as a household or other suitable entity. The subscriber domain may include the gateway 151 such as a so-called cable modem, potentially with a voice interface and ports, or other suitable entity. Both the wireless router 131 and the gateway 151 may be located in the subscriber domain (home environment).

In one example, the gateway 151 is a so-called cable modem. The gateway resource 151 is in communication with the termination node 152 such as a so-called cable modem termination system or other suitable entity. In one example, communication link 186 (such as a cable connection) conveys the communications between the gateway 151 and the termination node 152 the any suitable protocol such as DOCSIS.

The wireless router 131 can be configured to receive power from any suitable resource. In one example, the gateway 151 receives power from the power source 171. The wireless router 131 can be configured to receive power over a respective communication link 185 extending between the wireless router 131 and the gateway resource 151. In one example, the power provided by the gateway 151 over communication link 185 is a so-called power over ethernet (PoE). In a further example, the PoE complies with IEEE 802.3bt Type 3 Class 6 standard, which can provide power up to 60 W via the Ethernet cable to the Wi-Fi 6E router.

It is noted that the wireless router 131 may experience a failure or glitch, or congestion, preventing the wireless router 131 from efficiently in timely communicating through the gateway resource 151 to the different server resources in the network 190. It is noted that a failure or glitch may also prevent the wireless router 131 from receiving communications from network 190 and corresponding server resources through the gateway 151 (such as a gateway resource or other suitable entity).

In one example, the wireless router 131 is assigned or includes a corresponding performance monitor 141. The performance monitor 141 such as management resources (such as management hardware, management software, or a combination of management hardware software) to control operation of the wireless router 131 may reside in the wireless router 131. Alternatively, the performance monitor 141 may be disparately located with respect to the wireless router 131.

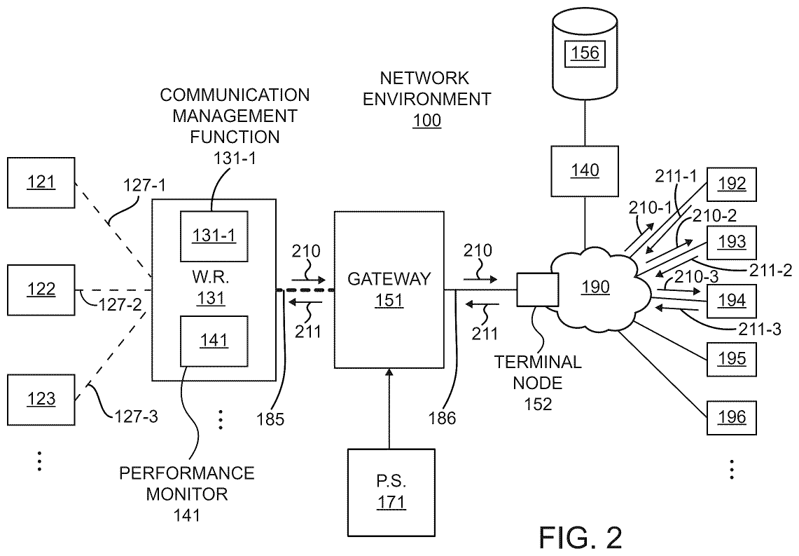

As further shown in FIG. 2, the performance monitor 141 (such as a controller or other suitable resource) can be configured to transmit test communications to one or more web servers (such as websites or other destinations) or other entities in the network environment 100 to determine a respective performance/health associated with the wireless router 131 and corresponding conveyance of communications through or over a

combination of communication link 185, gateway resource 151, communication link 186, and the network 190.

Note that the performance monitor 141 (a.k.a., management resource, wireless router controller, wireless router reset management resource, etc.,) and corresponding functions can be implemented in any suitable manner. For example, in one implementation, the performance monitor 141 is part of a software stack on the wireless router 131, which has many different functions including monitoring ping responses, rebooting the wireless router, supporting cloud connectivity and control, etc.

FIG. 2 is an example diagram illustrating transmission of one or more test communications to at least one remote network node in a network environment to test a performance of a respective wireless router as discussed herein.

More specifically, in this further example, in order to test the health (a.k.a., performance of timely supporting conveyance of communications between the communication devices in the destination server resources) of the wireless router 131 and determine whether it needs to be reset or not, at a first instant of time, the performance monitor 141 controls the wireless router 131 to transmit first communications 210 from the wireless router 131 over a combination of the communication link 185, gateway resource 151, communication link 186, and network 190 to one or more of the server resources 192, 193, 194, 195, 196, and so on.

Transmission of test communications may include transmission of the first test communications 210 (such as transmission of a first test communication) from the wireless router 131 through the gateway resource 151 in the network to the server resource 192, transmission of a second test communication from the wireless router 131 through the gateway resource 151 and the network 190 to the server resource 193, transmission of a third test communication from the wireless access at 131 through the gateway resource 131 and the network 190 to the server resource 194, and so on. The communications are transmitted to test an ability of the wireless router to communicate with at least one remote destination (different server resources 192, 193, 194, etc.).

In one example, the first test communications 210 are basically requests for retrieval of webpage information served by the respective server resource.

Subsequent to transmitting the test communications, the wireless router 131 monitors for receipt of first reply communications 211 from the at least one remote destination (i.e., different server resources 192, 193, 194, etc.).

As further discussed herein, depending upon a timeliness of the wireless router 131 receiving the reply communications 211 from the at least one remote destination, the performance monitor 141 controls a reset of the wireless router 131.

In other words, the wireless router 131 transmits communications 211 (the webpage information request) through the gateway resource 151 to the server resources 192, 193, 194, etc. If no response is received from any of the server resources based on the transmitted communications 211 within a threshold time duration, it is likely that the wireless router 131 is experiencing a respective failure. In such an instance, the performance monitor 141 can be configured to initiate a reset of the wireless router 131 and corresponding processing resource that supports the network access as previously discussed in FIG. 1.

Conversely, if the wireless router 131 does receive reply communications 211 from one or more of the server resources within a threshold amount of time, then the wireless router 131 may be deemed to be performing well and in good health. In this latter instance, the performance monitor 141 does not reset the wireless router 131 and corresponding processing resources (communication management function 131-1) supporting the network access to the communication devices.

In a further example, the performance monitor 141 (such as a controller) initiates the reset (such as a reboot of software such as communication management function 131-1 executed by the wireless router 131 to support network access discussed in FIG. 1) of the wireless router 131 in response to failure of the wireless router 131 receiving one or more reply messages (211) from any of the at least one remote destination within a threshold amount of time with respect to the first instant of time or thereabouts of transmitting the initial webpage request communications. In other words, if the performance monitor 141 detects that the ability of the wireless router 131 to communicate with one or more entities in the network environment through the gateway resource 151 falls below a threshold level, the performance monitor 141 or other suitable entity can be configured to reset the operation of the wireless router 131 with the hopes that the reset such as restart or reboot of the wireless router 131 and corresponding processing software supporting the network access will result in the ability of the wireless router 131 to provide proper operation again such as conveyance of communications between the mobile communication devices and the server resources in the network environment 100.

In one example, the performance monitor 141 prevents the reset of the wireless router 131 and corresponding processing resources supporting the network access in response to the wireless router 131 receiving at least one reply message from any of the remote destinations within a threshold amount of time with respect to the first instant of time. In other words, the wireless router 131 can be configured to transmit one or more webpage request messages (210) through the gateway resource 151 and the network 190 to one or more corresponding server resources. If the wireless router 131 receives corresponding one or more appropriate webpage request responses (211) from the server resources within a threshold amount of time with respect to the first instant of time, it is known that the wireless router 131 is operational and the corresponding network access processing software/functions 131-1 in the wireless router 131 do not need to be reset/rebooted. In such an instance, the performance monitor 141 prevents the reset of the wireless router 131 if the webpage reply messages (211) are received within a reasonable amount time of time with respect to a time of transmitting the original request messages (210).

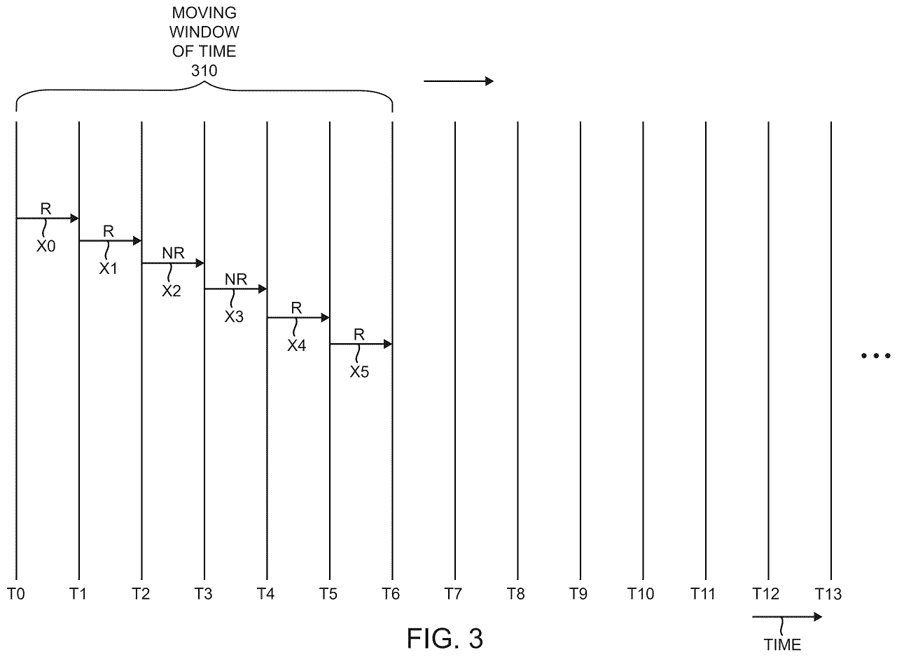

A specific example implementing transmission of test communications and monitoring for appropriate replies is further discussed in FIG. 3.

FIG. 3 is an example diagram illustrating a corresponding moving window of time with respect to times of transmitting messages to and receiving messages from a wireless router to determine performance of the wireless router as discussed herein.

In these further examples of FIG. 3, the performance monitor 141 can be configured to transmit multiple webpage request messages (210) as groups of test communications Xi spaced apart in time from each other such as at times T0, T1, T2, T3, . . . T10, T11, . . .

More specifically, at or around time T0, the performance monitor 141 causes the wireless router 131 to transmit a group X0 of one or more test messages 210 (such as webpage information request messages) to corresponding one or more server resources to determine the communication health of the wireless router 131. The performance monitor 141 keeps track of whether an appropriate response from any of the transmitted one or more test messages 210 is received by the wireless router 131. In one example, as further discussed below, the performance monitor software associated with the

performance monitor 141 configures the wireless router 131 to transmit the test messages every Xi seconds and wait for a response.

In this example, the marker R indicates that the wireless router 131 did receive a response (such as communications 211-1, 211-2, 211-3, etc.) from at least one of the webpage requests (such as communications 210-1, 210-2, 210-3, etc.) in the corresponding group Xi (where i is the # associated with the sample) within a threshold amount of time with respect to the time Ti. Conversely, the marker NR indicates that the wireless router 131 did not receive a response based on transmitting the at least one webpage requests the corresponding group Xi within a threshold amount of time with respect to time Ti. Note again that the technique of transmitting communications 210 (such as including communications 210-1, communications 210-2, communications 210-3, etc.) to one or more target servers and corresponding response communications 211 (communications 211-1, communications 211-2, communications 211-3, etc.) as shown in FIG. 2.

As shown in FIG. 3, in this example, after time T0, and up to time T1, assume that the wireless router 131 receives a communication response (communications 211) from one or more of the webpage requests (communications 210 such as from the wireless router 131 to each of the server resources 192, 193, and 194) transmitted in group X0 at or around time T0. In such an instance, the performance monitor 141 marks the test message group X0 transmitted at or around time T0 with a marker R indicating that a respective response (communications 211) was received such as within a time duration (such as time duration between T0 and time T1) such as 5 second or other amount.

At or around time T1, the performance monitor 141 causes the wireless router 131 to transmit a group X1 of one or more test messages 210 (such as webpage information request messages in communications 210 as previously discussed) to corresponding one or more server resources (192, 193, 194, etc.) to determine the health of the wireless router 131. The performance monitor 141 keeps track of whether an appropriate response from any of the transmitted one or more test messages 210 for the transmission at or around time T1 is received by the wireless router 131 for the group X1.

In this example, up to time T2, assume that the wireless router 131 receives a communication response (such as communications 211 including one or more of communications 211-1, 211-12, 211-3, etc.) from one or more of the webpage requests (communications 210 as previously discussed) transmitted in group X1 at or around time T1. In such an instance, the performance monitor 141 marks the test group X1 with a marker R indicating that a respective one or more responses (communications 211) was received such as within a time duration threshold level (such as duration of time between T1 and time T2) such as 5 second or other amount.

At or around time T2, the performance monitor 141 causes the wireless router 131 to transmit a group X2 of one or more test messages 210 (such as webpage information request messages including communications 210-1, 210-2, 210-3, etc.) to corresponding one or more server resources in a manner as previously discussed to determine the health of the wireless router 131. The performance monitor 141 keeps track of whether an appropriate response (such as communications 211-1, 211-2, 211-3, etc.) from any of the transmitted one or more test messages in communications 210 is received by the wireless router 131 for the group X2.

In this example, up to time T3, assume that the wireless router 131 does not

receive a communication response from any of the one or more of the webpage requests (210) transmitted in group X2 at or around time T2. In such an instance, the performance monitor 141 marks the test group X2 with a marker NR indicating that a respective response (211) was not received from any of the servers 192, 193, 194, etc., such as within a time duration (such as time duration between time T2 and time T3) such as 5 second or other amount. Note that for the transmitted test communications 210 in group X2, if as few as one website responds to the test communication and the wireless router 131 receives a response, then the circumstance is labeled as R (meaning that there was at least one response). If none of the websites response to the multiple queries associated with the test communications 210 in group X2, then it would be labeled as NR (meaning that there was no response from any of the test sites to which the test communications 210 transmitted. In one example, it is desirable to make sure that the wireless router 131 does not reboot/reset very often since it would negatively impact customer experience. Thus, as previously discussed, the performance monitor or other suitable entity may only reset one or more aspects of the respective wireless router 141 only when there are multiple instances of target servers not responding to the test communications 210.

At or around time T3, the performance monitor 141 causes the wireless router 131 to transmit a group X3 of one or more test messages 210 (such as webpage information request messages) to corresponding one or more server resources to determine the health of the wireless router 131. The performance monitor 141 keeps track of whether an appropriate response from any of the transmitted one or more test messages in communications 210 transmitted at or around time T3 is received by the wireless router 131 for the group X3.

In this example, up to time T4, assume that the wireless router 131 does not receive a communication response from any of the one or more of the webpage requests (210) in group X3 transmitted at or around time T3. In such an instance, the performance monitor 141 marks the test group X3 with a marker NR indicating that no response was received from any of the one or more server resources such as within a time duration (such as time duration between time T3 and time T4) such as 5 second or other amount. As previously discussed, if none of the websites responds to the transmitted test communications 210 associated with the group X3, such instances would be marked as NR. If one website responded, then it would be marked with an R.

At or around time T4, the performance monitor 141 causes the wireless router 131 to transmit a group X4 of one or more test messages 210 (such as webpage information request messages) to corresponding one or more server resources to determine the health of the wireless router 131. The performance monitor 141 keeps track of whether an appropriate response from any of the transmitted one or more test messages in communications 210 is received by the wireless router 131 for the group X4.

In this example, up to time T4, assume that the wireless router 131 receives a communication response from one or more of the webpage requests (210) transmitted at or around time T4. In such an instance, the performance monitor 141 marks the test group X4 with a marker R indicating that a respective response (211) was received such as within a time duration (such as time duration between time T4 and time T5) such as 5 second or other amount.

At or around time T5, the performance monitor 141 causes the wireless router 131 to transmit a group X5 of one or more test messages such as communications 210 (such as webpage information request messages) to corresponding one or more server resources to determine the health of the wireless router 131. The performance monitor 141 keeps track of whether an appropriate response (such as communications 211) from any of the transmitted one or more test messages in communications 210 is received by the wireless router 131 for the group X5.

In this example, up to time T5, assume that the wireless router 131 receives a communication response (211) from one or more of the webpage requests transmitted at or around time T5. In such an instance, the performance monitor 141 marks the test group X5 with a marker R indicating that a respective response was received such as within a time duration (such as time duration between time T5 and time T6) such as 5 second or other amount.

In one example, the performance monitor 141 implements the moving time window 310 to determine whether or not to set a flag associated with a respective error (poor performance) associated with the wireless router 131.

For example, if desired, the performance monitor 141 can be configured to determine that the wireless router 131 experiences a network access error for poor performance if the wireless router 131 does not receive a respective expected response (such as communications 211) from any of the server resources within any of the windows of time (such as window of time between time T0 and time T1, window of time between time T1 and time T2, window of time between time T2 and time T3, window of time between time T3 and time T4, window of time between time T4 and time T5, window of time between time T5 and time T6). In this example, as previously discussed, the performance monitor 141 detects that the wireless router 131 may experience multiple nonresponse (NR) conditions such as between time T2 and time T3 and between time T3 and time T4. However, in this example, the wireless router 131 does receive response communications in the other timeslots T0 to T1, T1 and T2, T4 and T5, T5 and T6. Thus, in this example, the performance monitor 141 does not generate an error flag associated with the wireless router 131 accessing the network 190 for the time window 310 between time T0 and time T6.

Thus, the performance monitor 141 can be configured to initiate transmission of a first test message (such as a first webpage request in communications 210-1) in group X1 from the wireless router 131 over communication link 185 such as a backhaul communication link to a first remote destination such as server resource 192 around the first instant of time; the performance monitor 141 can be configured to initiate transmission of a second test message in group X1 (such as a second webpage request in communications 210-2) from the wireless router 131 over the backhaul communication link (communication link 185) to a second remote destination (such as a second server resource 193 or, alternatively, server resource 192 again) around a second instant of time; the performance monitor 141 can be configured to initiate transmission of a third test message in group X1 (such as a second webpage request in communications 210-3) from the wireless router 131 over the backhaul communication link (communication link 185) to a third remote destination (such as a second server resource 194 or, alternatively, server resource 192 again) around a third instant of time. The first instant of time, the second instant of time, and the third instant of time may be approximately around time T0 or spread apart from each other by any amount.

The performance monitor 141 monitors for receipt of corresponding reply communications from the server resource 192, server resource 193, etc. For example, the performance monitor 141 of the wireless router 131 monitors or receipt of a first reply communication (211-1) from the first remote destination in response to transmitting the first test message (210-1). The performance monitor 141 of the wireless access at 131 further monitors for receipt of a second reply communication (211-2) from the second remote destination in response to transmitting the second test message (210-2), and so on. Depending upon a performance of receiving the first reply communication, second reply communication, etc., over one or more test (request/response) cycles, the performance monitor 141 can be configured to reset operation of the wireless router 131 in response to detecting a condition in which the performance is below a threshold level.

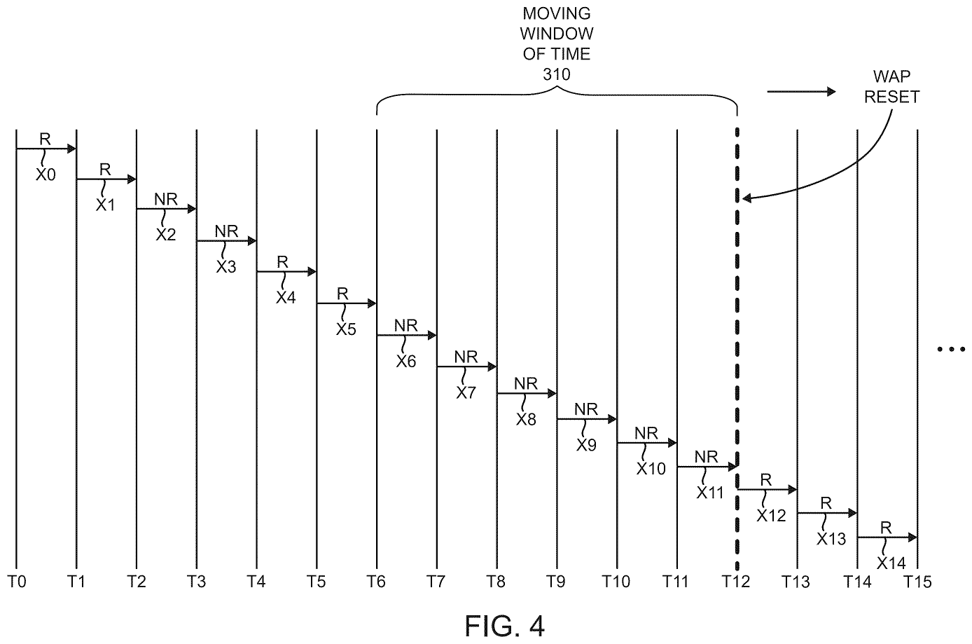

FIG. 4 is an example diagram illustrating a corresponding moving window of time with respect to times of transmitting request messages from and receiving response messages at a wireless router to determine performance of the wireless router as discussed herein.

This example illustrates how the performance monitor 141 initiates continued testing of the wireless router 131 via communication of respective test communications to one or more server resources in the network environment 100. However, in this example, the performance monitor 141 detects poor performance of the wireless router 131 based on the inability of the wireless router 131 receiving response communications from the server resources for multiple attempts between time T6 and time T12.

More specifically, at or around time T6, the performance monitor 141 causes the wireless router 131 to transmit a group X6 of one or more test messages in communications 210 (such as webpage information request messages) to corresponding one or more server resources to determine the health of the wireless router 131. The performance monitor 141 keeps track of whether an appropriate response (such as any of indications 211 in a manner as previously discussed) from any of the transmitted one or more test messages 210 is received by the wireless router 131 for the group X6.

In this example, up to time T7, assume that the wireless router 131 does not receive a communication response from any of the webpage requests transmitted in group X6 at or around time T6. In such an instance, the performance monitor 141 marks the test group X6 with a marker NR indicating that a respective response was not received such as within a time duration (such as time duration between time T6 and time T7) such as 5 second or other amount.

At or around time T7, the performance monitor 141 causes the wireless router 131 to transmit a group X7 of one or more test messages in communications 210 (such as webpage information request messages) to corresponding one or more server resources to determine the health of the wireless router 131. The performance monitor 141 keeps track of whether an appropriate response (211) from any of the transmitted one or more test messages 210 is received by the wireless router 131 for the group X7.

In this example, up to time T8, assume that the wireless router 131 does not receive a communication response from any of the one or more of the webpage requests transmitted in group X7 at or around time T7. In such an instance, the performance monitor 141 marks the test group X7 with a marker NR indicating that a respective response was not received such as within a time duration (such as time duration between time T7 and time T8) such as 5 second or other amount.

At or around time T8, the performance monitor 141 causes the wireless router 131 to transmit a group X8 of one or more test messages in communications 210 (such as webpage information request messages) to corresponding one or more server resources to determine the health of the wireless router 131. The performance monitor 141 keeps track of whether an appropriate response from any of the transmitted one or more test messages 210 is received by the wireless router 131 for the group X8.

In this example, up to time T9, assume that the wireless router 131 does not receive a communication response (211) from any of the one or more of the webpage requests transmitted in group X8 at or around time T8. In such an instance, the performance monitor 141 marks the test group X8 with a marker NR indicating that a respective response was not received such as within a time duration (such as time duration between time T8 and time T9) such as 5 second or other amount.

At or around time 9 the performance monitor 141 causes the wireless router 131 to transmit a group X9 of one or more test messages 210 (such as webpage information request messages) to corresponding one or more server resources to determine the health of the wireless router 131. The performance monitor 141 keeps track of whether an appropriate response from any of the transmitted one or more test messages 210 is received by the wireless router 131 for the group X9.

In this example, up to time T10, assume that the wireless router 131 does not receive a communication response from any of the one or more of the webpage requests transmitted in group X9 at or around time T9. In such an instance, the performance monitor 141 marks the test group X9 with a marker NR indicating that a respective response was not received such as within a time duration (such as time duration between time T9 and time T10) such as 5 second or other amount.

At or around time T10, the performance monitor 141 causes the wireless router 131 to transmit a group X10 of one or more test messages 210 (such as webpage information request messages) to corresponding one or more server resources to determine the health of the wireless router 131. The performance monitor 141 keeps track of whether an appropriate response from any of the transmitted one or more test messages 210 is received by the wireless router 131 for the group X10.

In this example, up to time T11, assume that the wireless router 131 does not receive a communication response from any of the one or more of the webpage requests transmitted in group X10 at or around time T10. In such an instance, the performance monitor 141 marks the test group X10 with a marker NR indicating that a respective response was not received such as within a time duration (such as time duration between time T10 and time T11) such as 5 second or other amount.

At or around time T11, the performance monitor 141 causes the wireless router 131 to transmit a group X11 of one or more test messages 210 (such as webpage information request messages) to corresponding one or more server resources to determine the health of the wireless router 131. The performance monitor 141 keeps track of whether an appropriate response from any of the transmitted one or more test messages 210 is received by the wireless router 131 for the group X11.

In this example, up to time T12, assume that the wireless router 131 does not receive a communication response from any of the one or more of the webpage requests transmitted in group X11 at or around time T11. In such an instance, the performance monitor 141 marks the test group X11 with a marker NR indicating that a respective response was not received such as within a time duration (such as time duration between time T11 and time T12) such as 5 second or other amount.

In this example, as previously discussed, the performance monitor 141 implements the moving window of time 310 to determine the performance associated with receiving response communications from the server resources between the time T6 and the time T12. In such an instance, the performance monitor 141 fails to detect any timely responses from the servers despite sending multiple groupings of request in a manner as previously discussed. In response to detecting the inability to receive response communications from the multiple different server resources for the moving window of time 310 in FIG. 4, the performance monitor 141 initiates reset of the communication management function 131-1. This may include a complete reboot of the processor corresponding memory associated with communication management unction 131-1 implement by the wireless router 131. In one example, the reset includes a reboot of the entire wireless router 131, which includes all the building blocks (circuitry, software, etc.) associated with the wireless router 131.

As further discussed below, the reset of the wireless router 131 or any of the functions or hardware therein, may depend upon detecting multiple instances of a respective window of time 310 indicating a failure of receiving appropriate response communications from any of the servers after the wireless resource 131 sends the test messages (communications 210).

Thus, in this example, the performance monitor 141 implements the moving time window 310 to determine whether or not to set a flag associated with a respective error (poor performance) associated with the wireless router 131. For example, if desired, the performance monitor 141 can be configured to determine that the wireless router 131 experiences a network access error if the wireless router 131 does not receive a respective response from any of the server resources within any of the windows of time (such as window of time between time T6 and time T7, window of time between time T7 and time T8, window of time between time T8 and time T9, window of time between time T9 and time T10, window of time between time T10 and time T11, window of time between time T11 and time T12). In this example, as previously discussed, the performance monitor 141 detects that the wireless router 131 experiences multiple nonresponse (NR) conditions such as every window of time including between time T6 and time T7, window of time between time T7 and time T8, window of time between time T8 and time T9, window of time between time T9 and time T10, window of time between time T10 and time T11, window of time between time T11 and time T12. Thus, in this example, the performance monitor 141 does generate an error flag associated with the wireless router 131 accessing the network 190.

As previously discussed, the performance monitor 141 can be configured to continuously monitor the ability of the wireless router 131 to communicate with one or more server resources at prespecified webpage addresses used for test communication purposes. The performance monitor 141 can be configured to initiate a reset of the wireless router 131 such as in response to detecting one or more instances of the moving window of time 310 detecting nonresponsive (NR) conditions in a manner as previously discussed.

In one example, there is no partial reboot. The wireless router 131 is power cycled on a reset condition. Note further that reset of one or more circuits in the wireless router 131 may include rebooting (memory and processing resources associated with) communication management function 131-1 in the wireless router 131 in response to a detected operational error condition associated with the wireless router 131. As previously discussed, the communication management function 131-1 can be configured to support routing of the communications passing through the wireless router 131 between the communication devices and the gateway. Further, as previously discussed, the operational error condition may be determined based at least in part on failure or delayed receipt of the wireless router 131 receiving the first reply communications (211) at the wireless router 131 in response to transmitting the first test communications (210) in each group. Further, as previously discussed, the communication management function 131-1 is operative to support wireless connectivity between multiple mobile communication devices and a remote network 190 during non-failure of the wireless router 131.

Yet further, as previously discussed, the performance monitor 141 can be configured to control the reset (such as reboot, repowering, POR or processor on reset, etc.) of the wireless router 131 based on the monitoring for receipt of the first reply communications and the second reply communications. In one example, the performance monitor 141 or other suitable entity the initiates reset of the of the wireless router 131 or any circuitry or processes therein at or around time T12. Subsequent to resetting the wireless router 131 at or around time T12, the performance monitor 141 continues to monitor the performance of the wireless router (wireless access point) in a similar manner as previously discussed between time window T12 to T13, time window T13 to T14, time window T14 to time T15, etc.

Referring again to FIG. 1, in further examples, based on the monitoring for receipt of first reply communications 211 in each of the time windows (T0 to T1, T1 to T2, etc.) and/or window 310, the performance monitor 141 or other suitable entity generates respective log information 156 (status information) indicating a communication failure associated with the wireless router 131 based at least in part on the wireless router failing to receive one or more reply communications in a manner as previously discussed. The performance monitor 141 can be configured to communicate the log information 156 from the wireless router 131 to a remotely located communication management system 140 (such as a communication management resource or other suitable entity), where the log information 156 is stored in a respective repository.

### Second Wireless Access Point Control System (Auto-Reset Control 2)

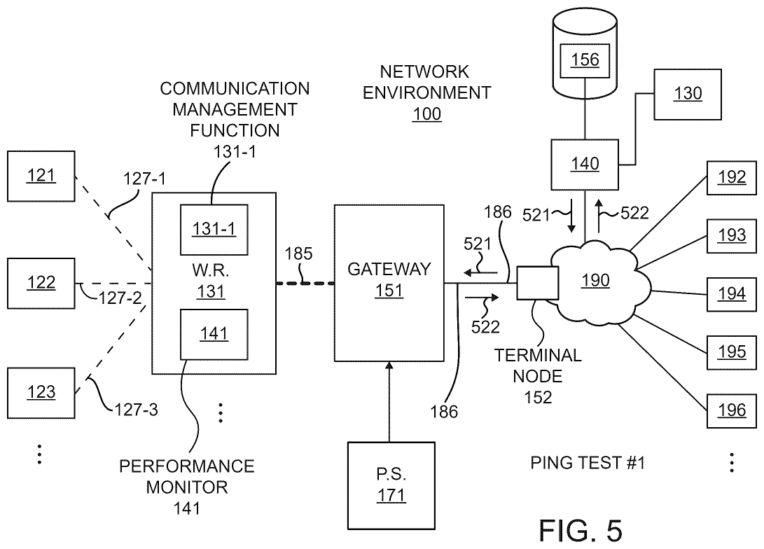

FIGS. 5-10 and corresponding description below describe implementation of a second reset system configured to reset one or more wireless routers in a network environment based on communication path testing results.

The communication system as discussed herein can be configured to use an SNMP-remote monitoring system such as SCOPE or other suitable entity to send real-time pings to modems and connected Wi-Fi routers. For example, the communication system can be configured to:
Use the Scope system to send real-time periodically ICMP requests to a cable modem such as D3.1 modem and the Wi-Fi™ 6E router
Adjust the ping (ICMP request) sending interval to 5 seconds
Use a 30 second time out window
   Initiate a retry attempt for another 30 second timeout window after the first 30-second window timeout failure occurred in order to mitigate false positive events
   Initiate from the OpenSync Cloud an auto-reboot for the Wi-Fi™ router (see further details below).

Auto-reboot Criteria:
Wi-Fi™ 6E Router ping (ICMP request/response) value>>Baseline Wi-Fi 6E Router ping value
[Wi-Fi™ Router ping value—D3.1 modem ping value or any modem ping value]>100 ms
Except if the router is unreachable

### Scope/OpenSync Cloud Monitoring

The remote telemetry monitoring of the successful and failed ping events can be done by either the SCOPE system or by the OpenSync Cloud. However, from implementation point of view, it may be desirable to initiate the auto-reboot command from the OpenSync Cloud.
Set-up a Scope monitoring for failed ping events, including a Grafana dashboard or another suitable dashboard
Exclude any Mains power failure events
Exclude any Wi-Fi™ 6E router firmware update
Periodically collect successful ping data to establish baseline Wi-Fi™ router/modem behavior
Initiate the auto-reboot command from the OpenSync Cloud
Collect these ICMP response failures to identify:
Identify Wi-Fi™ 6E router or modem issues in specific geo area
Identify patterns of failures for specific Wi-Fi 6E router's SW/HW implementation
Take preemptive actions when needed

More specifically, FIG. 5 is an example diagram illustrating a network environment and corresponding communication management resource implementing a second wireless router reboot control method and corresponding implementation of a first test ping as discussed herein.

In one example, communication system 140 may be a SCOPE system or other suitable entity that transmits the ping communications to the gateway 151. In this example, the communication management system 140 tests the communication capabilities associated with the gateway 151.

The multiple ping tests as discussed herein include a first ping test in which the communication management system 140 or other suitable entity transmits test communications 521 (ping) over the network 190 through the termination node 152 and corresponding communication link 186 to the gateway resource 151. The communication management system 140 keeps track of a time (such as time T51) of transmitting the communications 521.

Further in this example, the gateway resource 151 receives the communications 521 and, in response, generates the response communications 522. For example, the gateway resource 151 generates the communications 522 in response to receipt of the communications 521 (such as a request to transmit a reply or response communication such as a ping response to the communication management system 140). The gateway resource transmits the communications 522 (ping response) over the communication link 186 and through a combination of the termination node 152 and network 190 to the communication management system 140.

The communication management resource keeps track of a respective time (time T52) of receiving the communications 522 (ping response communications from the gateway 151).

A time difference between the time T52 and time T51 represents a so-called round-trip time of transmitting communications 521 from the communication management system 140 and receiving a response communication 522 from the communication management system 140.

Note that the ping test #1 can be repeated any number of times to determine the ability to communicate between the communication management resource 141 and the gateway 151.

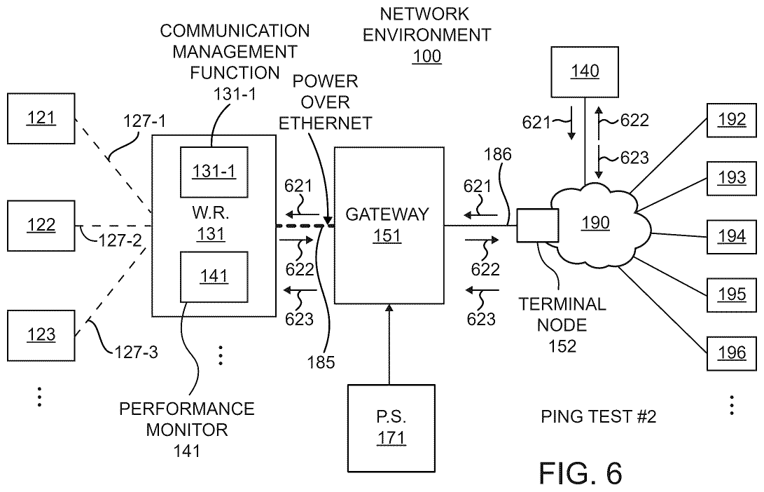

As further discussed below in FIG. 6, the communication management system 140 or other suitable entity the initiates a second ping test via communicating with the wireless router 131 through the gateway resource 151.

FIG. 6 is an example diagram illustrating a network environment and corresponding communication management system 140 implementing the second wireless router reset control method and corresponding implementation of a second test ping as discussed herein.

As previously discussed, the multiple ping tests as discussed herein further include a second ping test in which the communication management system 140 or other suitable entity transmits test communications 621 (ping) over the network 190 through the termination node 152 and corresponding communication link 186 and the gateway resource 151 and the communication link 185 to the wireless router 131. The communication management system 140 keeps track of a time (such as time T61) of transmitting the communications 621.

Further in this example, the wireless router 131 receives the communications 621 and generates the communications 622. The wireless router 131 immediately generates the communications 622 in response to receipt of the communications 621 (such as a request to transmit a reply communications such as a ping response to the communication management system 140). The wireless router 131 immediately after receiving the communications 621 transmits the communications 622 over the communication link 185 and through a combination of the gateway resource 151, termination node 152, and network 190 to the communication management system 140.

The communication management resource keeps track of a respective time (time T62) of receiving the communications 622 (ping response communications).

A time difference between the time T62 and time T61 represents a so-called round-trip time of transmitting communications from the communication management resource 140 to the wireless router 131 and receiving a response communication 622 from the wireless router 131 at the communication management system 140.

Note that the ping test #2 can be repeated any number of times to determine the ability to communicate between the communication management resource 141 and the gateway 151.

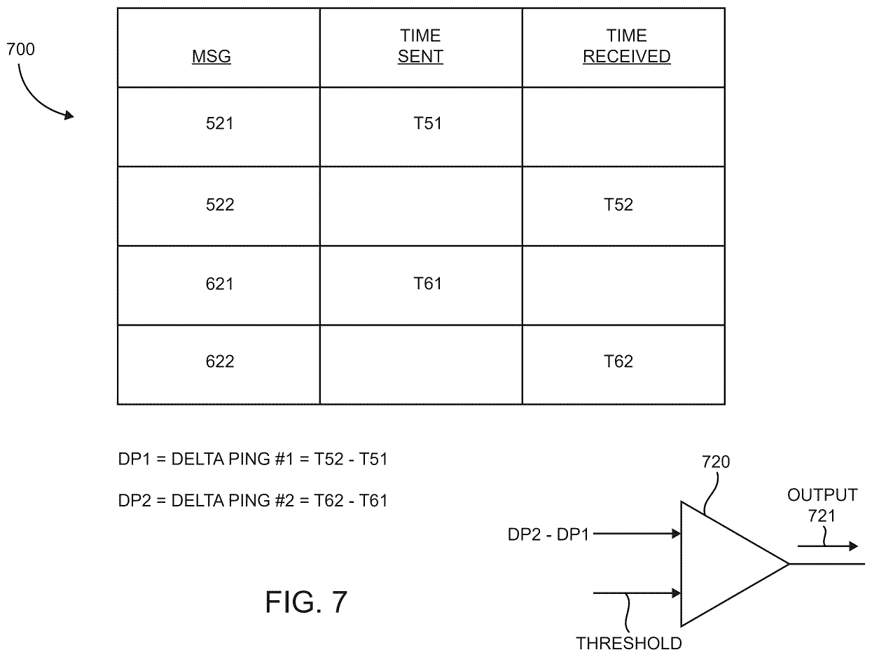

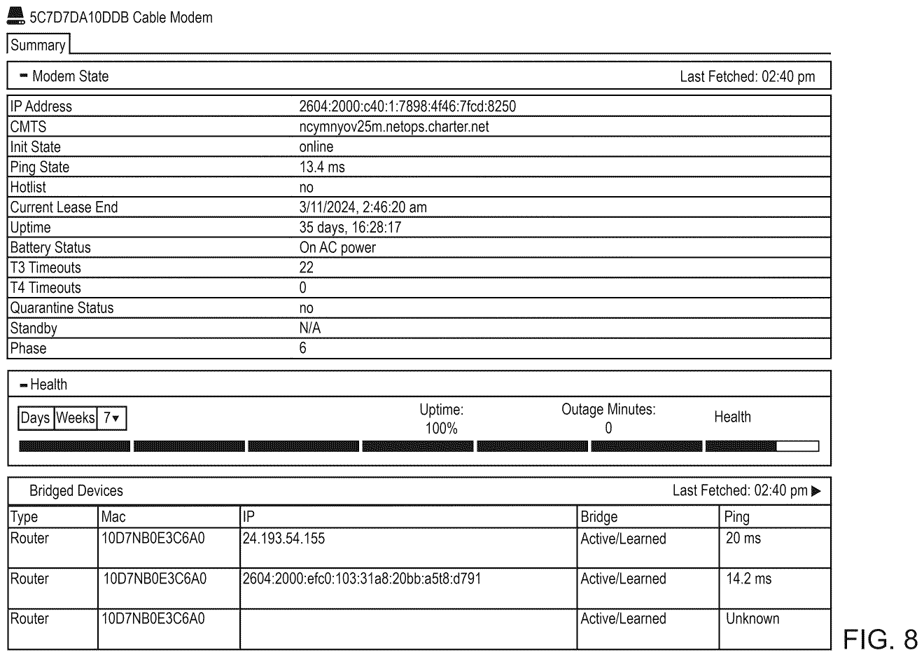

FIG. 7 is an example diagram illustrating a method of determining whether to issue a reset of a respective wireless router based multiple test ping tests as discussed herein. Note that an example of dashboard information associated with the respective wireless router is shown and discussed in FIG. 8 below.

Note again that the communication management system 140 or other suitable entity can be configured to implement the ping test #1 (FIG. 5) and the ping test #2 (FIG. 6) any number of times to determine a health/performance of the wireless router 131. The ping test #1 provides a baseline of delay (first delay) associated with round-trip communications between the communication management resource 140 and the gateway resource 151. It is presumed that the second delay associated with the ping test #2 is longer than the first delay because data packets must travel a longer distance for the communication path between the communication management system 140 and the wireless router 131 with respect to the shorter distance associated with the communication path between the communication management resource 140 and the gateway resource 151.

The one or more ping test #2 provide a second delay for comparison to the first delay generated for the one or more ping test #1. In general, if the difference between the second delay (such as time DP2) and the first delay (such as time DP1) is small, then it is assumed that the wireless router 131 is performing properly and above a performance threshold level. Conversely, if the difference between the second delay and the first delay is large, such as greater than a threshold level, then it is assumed that the wireless router 131 and corresponding communication management function 131-1 is performing poorly and potentially needs to be reset to alleviate any congestion or fault issues associated with it.

Thus, as shown in FIG. 7, the communication management system 140 can be configured to keep track of the test information 700 indicating a time T51 of transmitting the communications 521 associated with the ping #1 test to the gateway resource 151. The communication management system 140 also keeps track of the time T52 associated with the communication management system 140 receiving the ping reply communications 522 from the gateway resource 151 for the ping #1 test. The ICMP request/response time DP1 associated with test communications 521 and communications 522 is equal to a difference between time T52 (response such as ICMP response) and time T51 (ping such as ICMP request). Note again that the communication management system 140 can be configured to repeatedly perform the ping #1 test to produce an average value for the round-trip time DP1.

The communication management system 140 further can be configured to keep track of the test information 700 indicating a time T61 of transmitting the communications 621 and communications 622 associated with the ping #2 test to the wireless router 131. The communication management system 140 also keeps track of the time T62 associated with the communication management system 140 receiving the ping reply communications 622 from the wireless router 131. The round-trip time DP2 associated with test communications 621 is equal to a difference between time T62 and time T61. Note that the communication management system 140 can be configured to repeatedly perform the ping #2 test to produce an average value for the round-trip time DP2.

Further in this example, can be configured to compare a difference (such as average difference) between the round-trip time (DP2) associated with the ping #2 and the average round-trip time (DP1) associated with the ping #1 further with respect to a threshold level 710 to produce an output 721 indicating a relative performance associated with the wireless router 131.

More specifically, via the comparator 720, the communication management system 140 generates the output 721. In a first case where the difference between the round-trip time DP2 (such as average round-trip time associated with multiple instances of implementing ping #2 testing) and the round-trip time DP1 (such as average round-trip time associated with multiple instances of implementing ping #1 testing) is greater than a threshold level 710, the comparator 720 produces the output 721 indicating that the performance of the wireless router 131 is unacceptable. In such an instance, the communication management system 140 is configured to transmit a reset command 623 (FIG. 6) to reboot the communication management function 131-1 in the wireless router 131.

Execution of the reset command 623 at the wireless router 131 may result in complete or partial depowering of the wireless router 131 and the corresponding communication management function 131-1. Execution of the reset command 623 by the wireless router 131 may result in any of one or more circuits or hardware in the wireless router 131 being reset or rebooted.

Thus, in one example, the communication of the reset command 623 to the wireless router 131 can be configured to cause a reboot of the corresponding communication management function 131-1, at which time the wireless router 131 is temporarily unavailable for use by the mobile communication devices (121, 122, 123, etc.) because the communication management function 131-1 is being reset or rebooted. After reboot of the communication management function 131-1, the wireless router 131 provides the communication devices (such as mobile communication devices) access to the remote network 190 through the gateway resource 151 again. In other words, subsequent to completion of rebooting of the wireless router 131, the wireless router is configured to provide multiple communication devices access to the remote network 190 via wireless connectivity 127 between the wireless router and the multiple communication devices (i.e., mobile communication devices).

Additionally, in a first case where the difference between the time DP2 (such as average round-trip time associated with multiple instances of implementing ping #2 testing) and the time DP1 (such as average time associated with multiple instances of implementing ping #1 testing) is less than a threshold level 710, the comparator 720 produces the output 721 indicating that the performance of the wireless router 131 is acceptable. In such an instance, the communication management system 140 can be configured to prevent transmission of a reset command 623 to reset the communication management function 131-1 in the wireless router 131. Prevention of transmitting the reset command 623 to the wireless router 131 prevents a reboot of the corresponding communication management function 131-1 or reset of any of the hardware or software in the wireless resource 131 because it is presumed that the wireless router 131 is healthy (providing good service to the communication devices).

Thus, examples herein include the communication management system 140 receiving a time value DP2 associated with transmission of the first test communications over a network 190 and through a gateway resource 151 to a wireless router 131, where the gateway resource 151 provides the wireless router 131 connectivity to a remote network 190. The communication management system 140 further receives a time value DP1 associated with transmission of second test communications over the network 190 to the gateway resource 151. The communication management system 140 determines the operational state (such as performance, health, etc.) of the wireless router 131 based upon the time value DP2 and the time value DP1.

In one example, as previously discussed, the communication management system 140 can be configured to determine the operational state of the wireless router 131 via calculating a difference value based on a difference between time value DP2 and time value DP1. As previously discussed, the magnitude of the time value DP2 may be greater than the magnitude of the time value DP1 by a small amount or large amount.

Further, as previously discussed, the communication management system 140 can be configured to implement the comparator 720 to compare a magnitude of the difference value (DP2-DP1) to a threshold level 710 and produce a notification (such as output 721) indicating the operational state of the wireless router 131 as being a failure state or congested state in response to detecting that the magnitude of the difference value DP2-DP1 is greater than the threshold level 710. In such an instance, in response to detecting that the operational state of the wireless router is a failure for congested state, the communication management system 140 or other suitable entity transmits a reset control command 623 to the wireless router 131. The execution of the reboot control command at the wireless access at 131 reboots the wireless router 131.

It is noted that the comparator 720 (shown as a logical or physical representation) can be implemented in any suitable manner such as via hardware, software, or a combination of both. In one example, the comparison function (such as DP2-DP1 compared with respect to a threshold 710) as implemented by the comparator 720 can be done in software very effectively.

In further examples, the communication management system 140 or other suitable at and be configured to generate log information 156 indicating the failure or congested or poorly functioning state associated with the wireless router 131. The communication management system 140 or other suitable entity stores the log information 156 in a respective repository.

FIG. 8 is an example diagram illustrating a dashboard indicating a respective health of a wireless router and corresponding network as discussed herein.

In one embodiment, FIG. 8 shows that the ICMP Request and Reply messages are being sent every 30 seconds or other suitable time duration to the gateway resource 151 (such as a modem) and the wireless router 131 (such as a router behind gateway resource 151) by a so-called Scope system which:
records both T3 and T4 timer events
where time T3=200 ms—wait for modem ranging response
where T4=30 seconds—wait for modem unicast ranging opportunity

For example, the communication management system 140 can be configured to display the corresponding dashboard information 800 on the display screen 130 for viewing by a respective user.

The dashboard information 800 indicates information associated with the wireless router 131 and its corresponding status of providing wireless services.

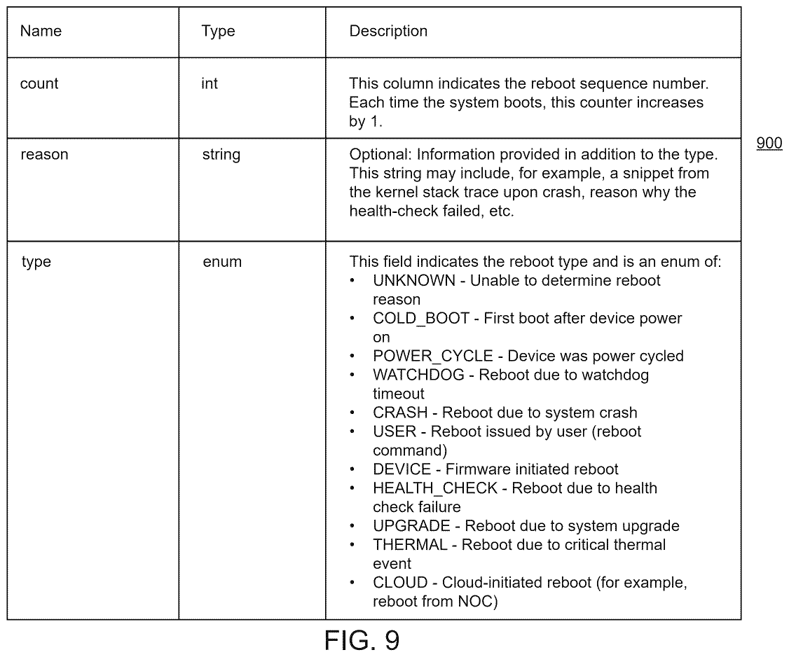

FIG. 9 is an example diagram illustrating parameters associated with creating a table of information indicating occurrence of different types of wireless router failures as discussed herein.

For example, the status information 900 and FIG. 9 includes a table enabling reporting of the reasons associated with reboot/boot of the respective wireless router 131. Note that entries in this table (900) may be automatically populated by the respective wireless router upon startup. If desired, table rows they be persistent until deleted.

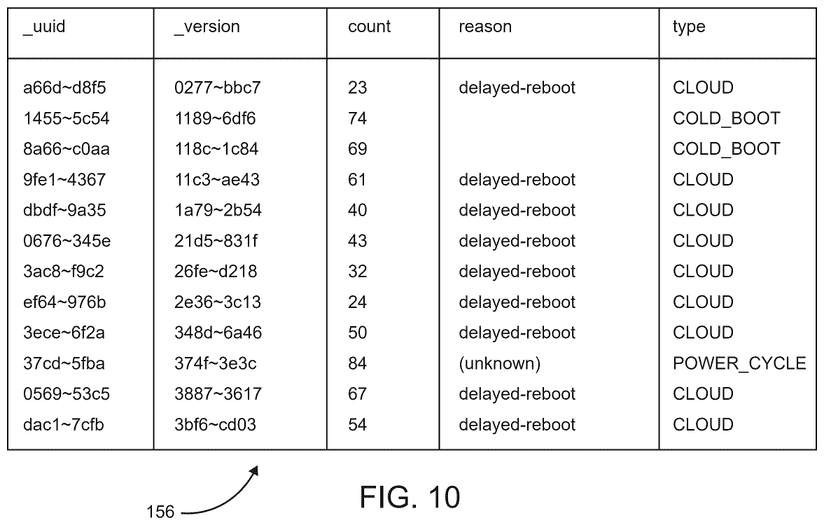

FIG. 10 is an example diagram illustrating a log of wireless router failures as discussed herein.

As previously discussed, techniques herein include generating log information 156 indicating the identity of the wireless routers as well as corresponding reasons that those wireless routers were rebooted. Accordingly, the log information 156 is beneficial to identify wireless routers that may need to be replaced or fixed.

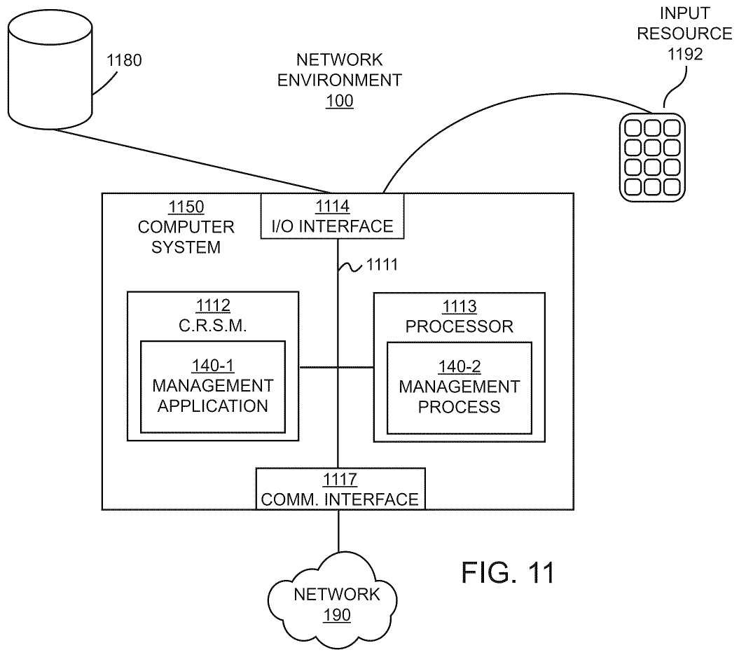

FIG. 11 is an example block diagram of a computer system for implementing any of the operations as discussed herein.

Note that any of the resources (such as communication management system 140, wireless router 131, the communication management function 131-1, gateway resource 151, performance monitor 141, or other suitable entity) as discussed herein can be configured to include computer processor hardware and/or corresponding executable instructions to carry out the different operations as discussed herein.

For example, as shown, computer system 1150 of the present example includes interconnect 1111 coupling computer readable storage media 1112 such as a non-transitory type of media (which can be any suitable type of hardware storage medium in which digital information can be stored and or retrieved), a processor 1113 (computer processor hardware), I/O interface 1114, and a communications interface 1117. I/O interface(s) 1114 supports connectivity to repository 1180 and input resource 1192.

Computer readable storage medium 1112 can be any hardware storage device such as memory, optical storage, hard drive, floppy disk, etc. In one example, the computer readable storage medium 1112 is computer readable storage hardware that stores instructions and/or data.

As shown, computer readable storage media 1112 can be encoded with management application 140-1 (e.g., including instructions associated with any of the following resources such as communication management system 140, wireless router 131, the communication management function 131-1, gateway resource 151, performance monitor 141) in a respective wireless station to carry out any of the operations as discussed herein.

During operation of one example, processor 1113 accesses computer readable storage media 1112 via the use of interconnect 1111 in order to launch, run, execute, interpret or otherwise perform the instructions in management application 140-1 stored on computer readable storage medium 1112. Execution of the management application 140-1 (communication management application) produces management process 140-2 (communication management process) to carry out any of the operations and/or processes as discussed herein.

Those skilled in the art will understand that the computer system 1150 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless router, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein.

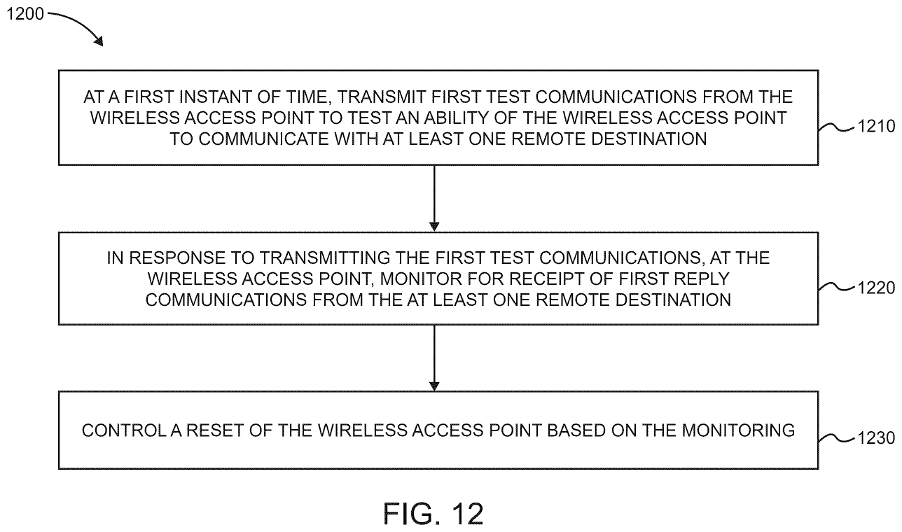

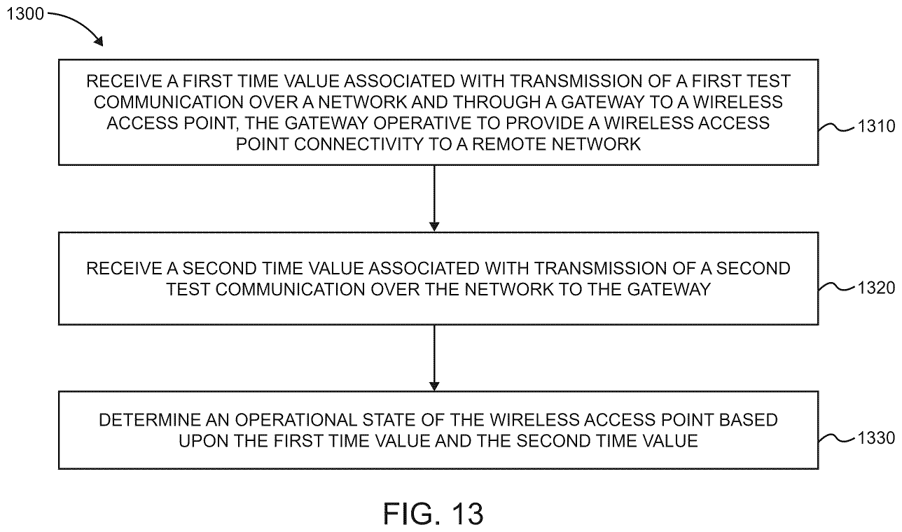

Functionality supported by the different resources will now be discussed via flowchart in FIG. 12 and FIG. 13. Note that the steps in the flowcharts below can be executed in any suitable order.

FIG. 12 is a flowchart 1200 illustrating an example method according to examples herein. Note that there will be some overlap with respect to concepts as discussed above because the flowchart 1200 captures the general ideas as previously presented.

In processing operation 1210, at a first instant of time, the communication management resource 141 transmits first test communications from the wireless router to test an ability of the wireless router to communicate with at least one remote destination.

In processing operation 1220, the communication management resource 141 monitors for receipt of first reply communications at the wireless router in response to transmitting the first test communications.

In processing operation 1230, the communication management resource 141 controls a reset of the wireless router based on the monitoring.

FIG. 13 is a flowchart 1300 illustrating an example method according to examples herein. Note that there will be some overlap with respect to concepts as discussed above because the flowchart 1300 captures the general ideas as previously presented.

In processing operation 1310, the communication management resource 940 produces a first time value associated with transmission of a first test communication over a network and through a gateway to a wireless router. As previously discussed, the gateway is configured to operative to provide a wireless router connectivity to a remote network.

In processing operation 1320, the communication management resource 940 produces a second time value associated with transmission of a second test communication over the network to the gateway.

In processing operation 1330, the communication management resource 940 determines an operational state of the wireless router based upon the first time value and the second time value.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of

physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
at a first instant of time, transmitting first communications from a wireless router to at least one remote destination;
at the wireless router, monitoring for receipt of first reply communications in response to transmitting the first communications to determine a performance of the wireless router; and
controlling a reset of the wireless router based on the monitoring.

2. The method as in claim 1, wherein the first communications are first test communications communicated from the wireless router to the at least one remote destination to determine a performance of the wireless router;
wherein controlling the reset of the wireless router based on the monitoring includes: initiating the reset of the wireless router in response to failure of the wireless router receiving a reply message from any of the at least one remote destination within a threshold amount of time with respect to the first instant of time.

3. The method as in claim 1, wherein controlling the reset of the wireless router based on the monitoring includes:
preventing the reset of the wireless router in response to the wireless router receiving at least one reply message from any of the at least one remote destination within a threshold amount of time with respect to the first instant of time.

4. The method as in claim 1, wherein transmitting the first communications includes:
transmitting a first test message from the wireless router over a backhaul communication link to a first remote destination around the first instant of time; and
transmitting a second test message from the wireless router over the backhaul communication link to a second remote destination around a second instant of time.

5. The method as in claim 4, wherein monitoring for receipt of reply communications at the wireless router includes:
monitoring for receipt of a first reply communication from the first remote destination in response to transmitting the first test message; and
monitoring for receipt of a second reply communication from the second remote destination in response to transmitting the second test message.

6. The method as in claim 1 further comprising:
at a second instant of time subsequent to the first instant of time, transmitting second communications from the wireless router to test the ability of the wireless router to communicate with the at least one remote destination; and
monitoring for receipt of second reply communications at the wireless router in response to transmitting the second communications.

7. The method as in claim 6 further comprising:
controlling the reset of the wireless router based on the monitoring for receipt of the first reply communications and the second reply communications.

8. The method as in claim 1 further comprising:
based on the monitoring for receipt of first reply communications, generating log information indicating a communication failure associated with the wireless router based at least in part on the wireless router failing to receive the first reply communications; and
communicating the log information from the wireless router to a remotely located communication management resource.

9. The method as in claim 1, wherein the wireless router is configured to provide multiple communication devices access to a remote network via wireless connectivity between the wireless router and the multiple communication devices.

10. The method as in claim 1, wherein controlling the reset of the wireless router based on the monitoring includes:
rebooting a communication management function in the wireless router in response to a detected operational error condition associated with the wireless router, the operational error condition determined based at least in part on failure to receive the first reply communications at the wireless router in response to transmitting the first communications, the communication management function operative to support wireless connectivity between multiple communication devices and a remote network during non-failure of the wireless router.

11. A system comprising:
management hardware operative to:
at a first instant of time, transmit first test communications from the wireless router to test an ability of the wireless router to communicate with at least one remote destination;
monitor for receipt of first reply communications at the wireless router in response to transmitting the first test communications; and
control a reset of the wireless router based on the monitoring.

12. The system as in claim 11, wherein the management hardware is further operative to:
initiate the reset of the wireless router in response to failure of the wireless router receiving a reply message from any of the at least one remote destination within a threshold amount of time with respect to the first instant of time.

13. The system as in claim 11, wherein the management hardware is further operative to:
prevent the reset of the wireless router in response to the wireless router receiving at least one reply message from any of the remote destinations within a threshold amount of time with respect to the first instant of time.

14. The system as in claim 11, wherein the management hardware is further operative to:
transmit a first test message from the wireless router over a backhaul communication link to a first remote destination around the first instant of time; and
transmit a second test message from the wireless router over the backhaul communication link to a second remote destination around a second instant of time.

15. The system as in claim 14, wherein the management hardware is further operative to:
monitor for receipt of a first reply communication from the first remote destination in response to transmitting the first test message; and
monitor for receipt of a second reply communication from the second remote destination in response to transmitting the second test message.

16. The system as in claim 11, wherein the management hardware is further operative to:
at a second instant of time subsequent to the first instant of time, transmit second test communications from the wireless router to test the ability of the wireless router to communicate with the at least one remote destination; and
monitor for receipt of second reply communications at the wireless router in response to transmitting the second test communications.

17. The system as in claim 16, wherein the management hardware is further operative to:
control the reset of the wireless router based on the monitoring for receipt of the first reply communications and the second reply communications.

18. The system as in claim 11, wherein the management hardware is further operative to:
based on the monitoring for receipt of first reply communications, generate log information indicating a communication failure associated with the wireless router based at least in part on the wireless router failing to receive the first reply communications; and
communicate the log information from the wireless router to a remotely located communication management resource.

19. The system as in claim 11, wherein the wireless router is configured to provide multiple communication devices access to a remote network via wireless connectivity between the wireless router and the multiple communication devices.

20. The system as in claim 11, wherein the management hardware is further operative to:
reboot a communication management function in the wireless router in response to a detected operational error condition associated with the wireless router, the operational error condition determined based at least in part on failure to receive the first reply communications at the wireless router in response to transmitting the first test communications, the communication management function operative to support wireless connectivity between multiple communication devices and a remote network during non-failure of the wireless router.

21. A method comprising:
receiving a first time value associated with transmission of a first test communication over a network and through a gateway to a wireless router, the gateway operative to provide a wireless router connectivity to a remote network;
receiving a second time value associated with transmission of a second test communication over the network to the gateway; and
determining an operational state of the wireless router based upon the first time value and the second time value.

22-40. (canceled)

41. Computer-readable storage hardware having instructions stored thereon, the instructions, when carried out by computer processor hardware, cause the computer processor hardware to:
at a first instant of time, transmit first test communications from the wireless router to test an ability of the wireless router to communicate with at least one remote destination;
monitor for receipt of first reply communications at the wireless router in response to transmitting the first test communications; and
control a reset of the wireless router based on the monitoring.

42. (canceled)
